(19) United States
(12) Patent Application Publication
(10) Pub. No.: US 2009/0060618 A1
(43) Pub. Date: Mar. 5, 2009

(54) Image forming apparatus and image processing apparatus

(75) Inventor: Shuichi Fujikura, Tokyo (JP)

Correspondence Address: KUBOTERA & ASSOCIATES, LLC, SUITE 202, 200 DAINGERFIELD ROAD, ALEXANDRIA, VA, 22314, US

(73) Assignee: Oki Data Corporation

(21) Appl. No.: 12/222,981

(22) Filed: Aug. 21, 2008

(30) Foreign Application Priority Data
Aug. 30, 2007 (JP) 2007-224074

(51) Int. Cl. G03G 15/00

(52) U.S. Cl. 399/407

(57) ABSTRACT

An image forming apparatus forms an image during conveyance of a medium. The image forming apparatus includes a conveying unit for conveying a medium, and a reverse voltage applying unit for applying to the medium a voltage with polarity opposite to a voltage applied to the medium when the conveying unit conveys the medium. An image processing apparatus includes a conveying unit for conveying an original document; a reading unit for reading an image on the original document during conveyance of the document; and a reverse voltage applying unit for applying to the medium a voltage with polarity opposite to a voltage applied to the medium when the conveying unit conveys the medium.

### BACKGROUND OF THE INVENTION AND RELATED ART STATEMENT

The present invention relates to an image forming apparatus and an image processing apparatus. More specifically, the present invention relates to an image forming apparatus and an image processing apparatus capable of stably conveying a medium after forming an image thereon or a document to read.

Generally, in an image forming apparatus that conveys a medium and forms an image thereon, or conveys an original document and reads an image thereon, a static elimination brush grounded to an outlet of the medium or the original document removes charges accumulated on the medium or the original document (refer to Patent Reference).

### Patent Reference: Japanese Patent Publication No. 10-302993

According to the image forming apparatus disclosed in Patent Reference, when the medium accumulates charges differently depending on a type of medium or an environment in conveying the medium such as a temperature or humidity, it is difficult to completely remove charges accumulated on the medium. Accordingly, when the medium is discharged, the medium may be adsorbed to or rejected from other medium already conveyed, thereby scattering the medium on a stacker. Especially when the medium has high impedance such as a film media like an OHP (overhead projector) sheet or a surface-coated medium, the phenomenon becomes evident.

In view of the above problems, an object of the present invention is to provide an image forming apparatus and an image processing apparatus capable of removing charges accumulated on a medium during conveyance thereof, thereby preventing the medium from being absorbed to other medium.

Further objects of the invention will be apparent from the following description of the invention.

### SUMMARY OF THE INVENTION

In order to solve the above problems, according to the present invention, an image forming apparatus forms an image during conveyance of a medium. The image forming apparatus includes a conveying unit for conveying a medium, and a reverse voltage applying unit for applying to the medium a voltage with polarity opposite to a voltage applied to the medium when the conveying unit conveys the medium.

According to the present invention, an image processing apparatus includes a conveying unit for conveying an original document; a reading unit for reading an image on the original document during conveyance of the document; and a reverse voltage applying unit for applying to the medium a voltage with polarity opposite to a voltage applied to the medium when the conveying unit conveys the medium.

In the present invention, the image forming apparatus or the image processing apparatus is provided with the reverse voltage applying unit. The reverse voltage applying unit applies to the medium the voltage with polarity opposite to the voltage charged on the medium when the conveying unit conveys the medium, thereby neutralizing charges on the medium. Accordingly, it is possible to eliminate charges from the medium, thereby preventing adsorption between media and the likes.

### BRIEF DESCRIPTION OF THE DRAWINGS

FIG. 1 is a schematic sectional view showing a major portion of a printer as an image forming apparatus according to a first embodiment of the present invention;

FIG. 2 is a schematic sectional view showing an image forming unit according to the first embodiment of the present invention;

FIG. 3 is a block diagram showing a print control unit of the printer according to the first embodiment of the present invention;

FIG. 4 is a flowchart showing an operation of the printer according to the first embodiment of the present invention;

FIG. 5 is a schematic view showing a sheet quality sensor of the printer according to the first embodiment of the present invention;

FIG. 6 is a table showing a relationship among a sheet quality, an environmental condition, a transfer voltage, and a static elimination voltage according to the first embodiment of the present invention;

FIG. 7 is a schematic sectional view showing a major portion of a scanner as an image processing device according to a second embodiment the present invention;

FIG. 8 is a schematic view showing a potential sensor according to the second embodiment of the present invention;

FIG. 9 is a block diagram showing a scanner control unit of the scanner according to the second embodiment of the present invention; and

FIG. 10 is a flowchart showing an operation of the scanner according to the second embodiment of the present invention.

### DETAILED DESCRIPTION OF THE PREFERRED EMBODIMENTS

Embodiments of the present invention will be explained with reference to the accompanying drawings.

### First Embodiment

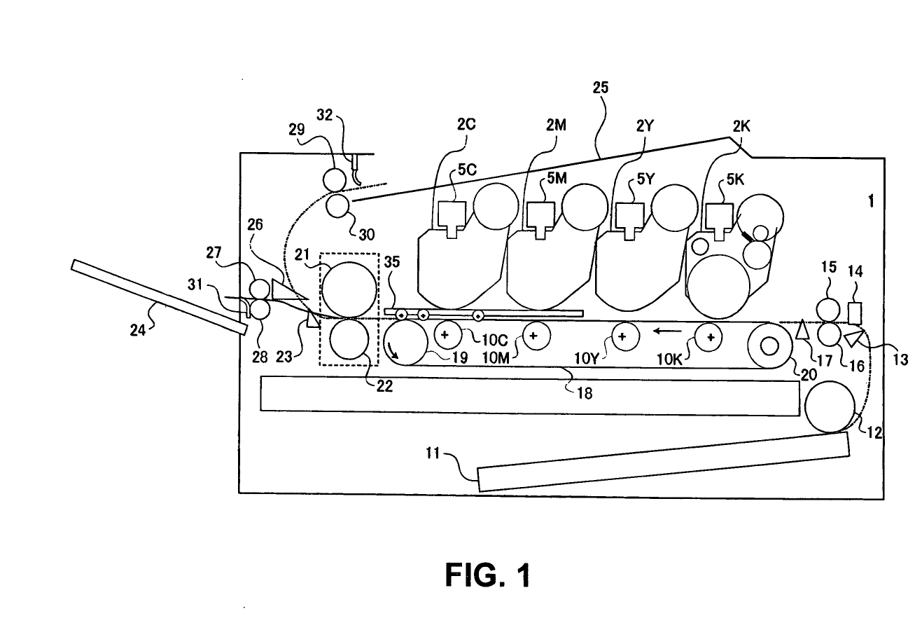

A first embodiment of the present invention will be explained. FIG. 1 is a schematic sectional view showing a major portion of a printer 1 as an image forming apparatus according to a first embodiment of the present invention.

As shown in FIG. 1, the printer 1 includes image forming units 2K, 2Y, 2M, and 2C for forming an image; transfer rollers 10K, 10Y, 10M, and 10C for transferring an developed image formed at the image forming units to a recording sheet as a medium through an electric potential difference; a sheet receiving unit 11 for storing a plurality of sheets therein and successively taking out the recording sheet therefrom; a sheet-feeding roller 12 for separating the recording sheet together with a separating tongue or the like and taking out the recording sheet from the sheet receiving section 11 one by one; an inlet sensor 13 for detecting whether the recording sheet is fed; a sheet quality sensor 14 for measuring a light reflectance of the recording sheet to determine a voltage to be applied onto the transfer rollers 10K, 10Y, 10M, and 10C or a static elimination voltage (described later); and convey rollers 15 and 16 for conveying the recording sheet in a printing direction.

In the embodiment, the printer 1 further includes a writing sensor 17 for detecting a front edge of the recording sheet to determine a timing that the image forming units start forming the image; a convey belt 18 formed of an endless belt for conveying the recording sheet; a belt driving roller 19 connected to a motor (not shown) via a gear (not shown) for moving the convey belt 18; a follower roller 20 supported with a spring for maintaining a tension of the convey belt 18 at a constant level; a fixing roller 21 having a heating element such as a halogen lamp therein for and heating and pressing the recording sheet to fix toner on the recording sheet; and a fixing backup roller 22 for pressing the recording sheet onto the fixing roller 21.

In the embodiment, the printer 1 further includes an ejection sensor 23 for monitoring whether the recording sheet is wound around a fixing device formed of the fixing roller 21 and the fixing backup roller 22; a face-up stacker 24 and a face-down stacker 25 for receiving the recording sheet ejected from the fixing device; an up-down separator 26 for switching between the a face-down stacker 24 and the face-up stacker 25 as an ejection destination of the recording sheet; ejection rollers 27 and 28 for ejecting the recording sheet to the face-up stacker 24; ejection rollers 29 and 30 for ejecting the recording sheet to the face-down stacker 25; and static elimination brushes 31 and 32 provided near ejecting outlets of the face-up stacker 24 and the face-down stacker 25 for supplying charges to the recording sheet.

In the embodiment, the printer 1 also includes a motor (not shown) for rotating each roller described above; a roller (not shown) disposed in a conveyance path at a distance not greater than a minimum interval between the recording sheet; and a solenoid (not shown) for switching a conveyance path. The motor functions as a sheet-feeding motor to mainly rotate the sheet-feeding roller 12, a convey motor to rotate the convey rollers 15 and 16, and a belt motor to rotate the belt driving roller 19. In addition, a fixing motor rotates the fixing roller 21 and the fixing backup roller 22, and four ID motors respectively rotate rollers respectively formed in the image forming units 2K, 2Y, 2M, and 2C.

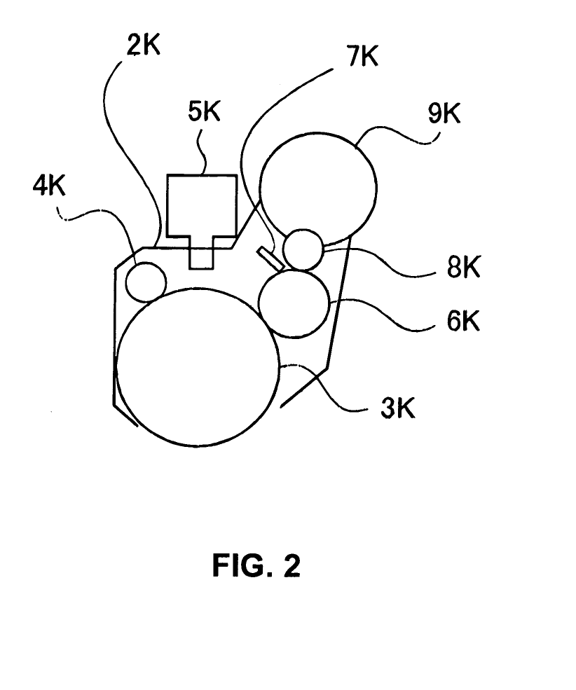

In the embodiment, the image forming units 2K, 2Y, 2M, and 2C use developer in different colors and have a same configuration. Therefore, the image forming unit 2K will be explained as an example. FIG. 2 is a schematic sectional view showing the image forming unit 2K according to the first embodiment of the present invention.

As shown in FIG. 2, the image forming unit 2K is formed of a photosensitive drum 3K for forming an electrostatic latent image thereon; a charge roller 4K for charging a surface of the photosensitive drum 3K; a LED (light emitting diode) head 5K for forming the electrostatic latent image on the surface of the photosensitive drum 3K charged by the charge roller 4K; a developing roller 6K for adhering toner to the electrostatic latent image formed on the photosensitive drum 3K to develop the electrostatic latent image; a developing blade 7K for controlling a thickness of a toner layer on the developing roller 6K; a sponge roller 8K for supplying toner to the developing roller 6K; and a toner tank 9K for supplying toner to the sponge roller 8K.

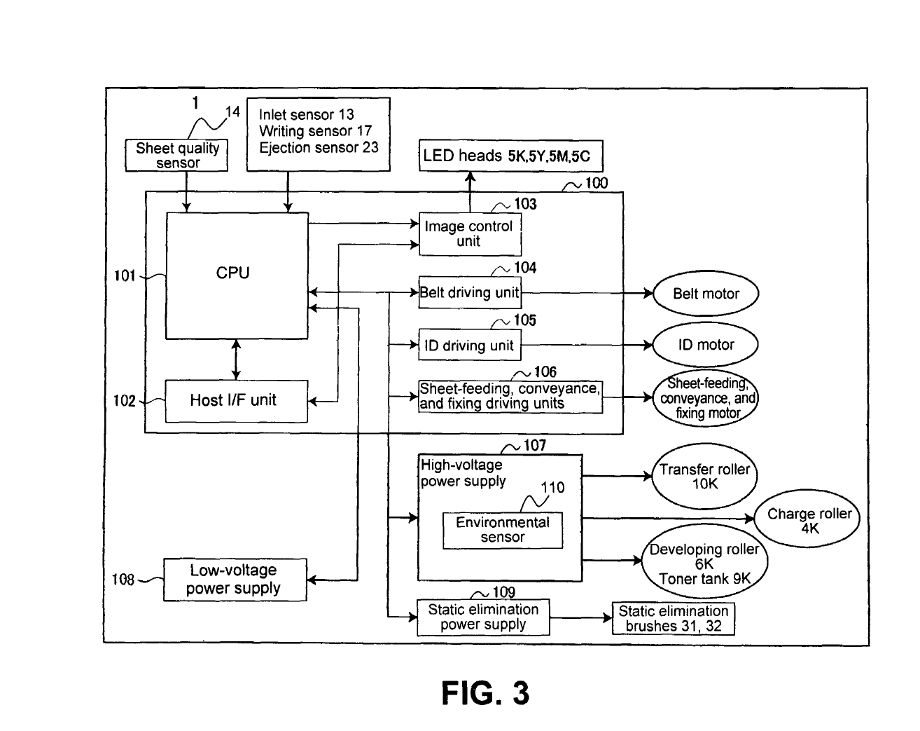

FIG. 3 is a block diagram showing a print control unit 100 of the printer 1 according to the first embodiment of the present invention. The printer control unit 100 includes a CPU (central processing unit) 101 that operates with a program written in a ROM (read only memory, not shown); a host I/F unit 102 to make wired or wireless connection with an external device such as a host computer; and an image control unit 103 to deploy fonts or form tones based on data received from the host computer or so, and control the LED heads 5K, 5Y, 5M, and 5C.

In the embodiment, the printer control unit 100 further includes a belt driving unit 104 to output a phase signal for driving the belt motor and to generate a current reference; an ID driving unit 105 to control motor driving in the image forming units 2K, 2Y, 2M, and 2C; and a sheet-feeding, conveyance, and fixing driving unit 106 to control driving of the sheet-feeding motor, the convey motor, and the fixing motor.

In addition, the printer 1 further includes a high-voltage power supply 107 to provide high-voltage electric power to the charge roller, the transfer roller, and so on; a low-voltage power supply 108 to supply 5 V and 24 V electric voltages to circuits and motors; a static elimination power supply 109 as a reverse voltage applying unit to apply a static elimination voltage; and an environmental sensor 110 formed of a thermistor and a polymer-type humidity sensor to monitor a temperature and a humidity.

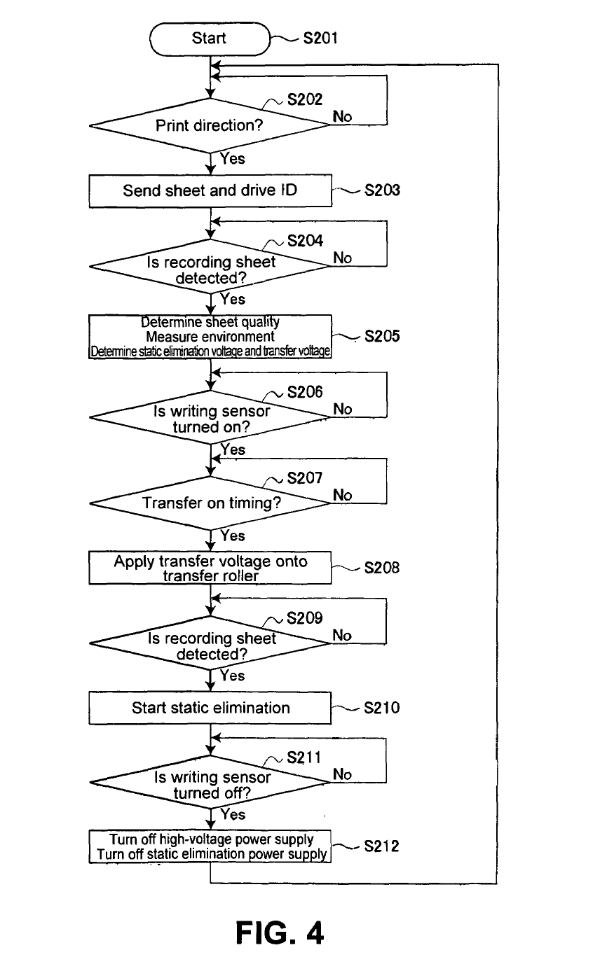

Hereunder, an operation of the printer 1 will be described. FIG. 4 is a flowchart showing the operation of the printer 1 according to the first embodiment of the present invention. The printer 1 is connected to the host computer or the like via the host I/F unit 102 with a cable or wirelessly.

In Step S201, when the printer 1 is turned on, the CPU 101 reads the program recorded in the ROM (not shown) and starts a process routine. Processes such as color shift correction and density correction upon turning on the power are done at this time.

In Step S202, when the host computer or so transfers print data and the CPU receives a print direction, the CPU 101 sends a direction to start up the sheet-feeding, conveyance, and fixing driving unit 106. The sheet-feeding, conveyance, and fixing driving unit 106 starts the sheet-feeding roller and the conveyance motor. When the driving force is transmitted from the sheet-feeding motor to the sheet-feeding roller 12, the sheet-feeding roller 12 starts to rotate. After taking out one recording sheet 35 from the sheet receiving unit 11 in the sheet cassette, the sheet-feeding roller 12 sends the recording sheet 35 to the convey rollers 15 and 16.

In Step S203, when the CPU 101 sends directions to the belt driving unit 104 and the ID driving unit 105, the belt driving unit 104 drives the belt motor, and the ID driving unit 105 drives the ID motor, respectively. Furthermore, the CPU 101 sends directions to a fixing heating circuit (not shown) to heat so as to keep the temperature of the fixing device constant. The temperature of the fixing device in this step is set lower than a fixing temperature in an actual fixing process.

In Step S204, the inlet sensor 13 located on an upstream side of the convey rollers 15 and 16 detects whether the sheet-feeding roller 12 correctly feeds the recording sheet 35. In Step 205, when the inlet sensor 13 detects the recording sheet 35 (Yes in Step S204), the sheet quality sensor 14 determines whether the recording sheet 35 is an OHP or a normal sheet.

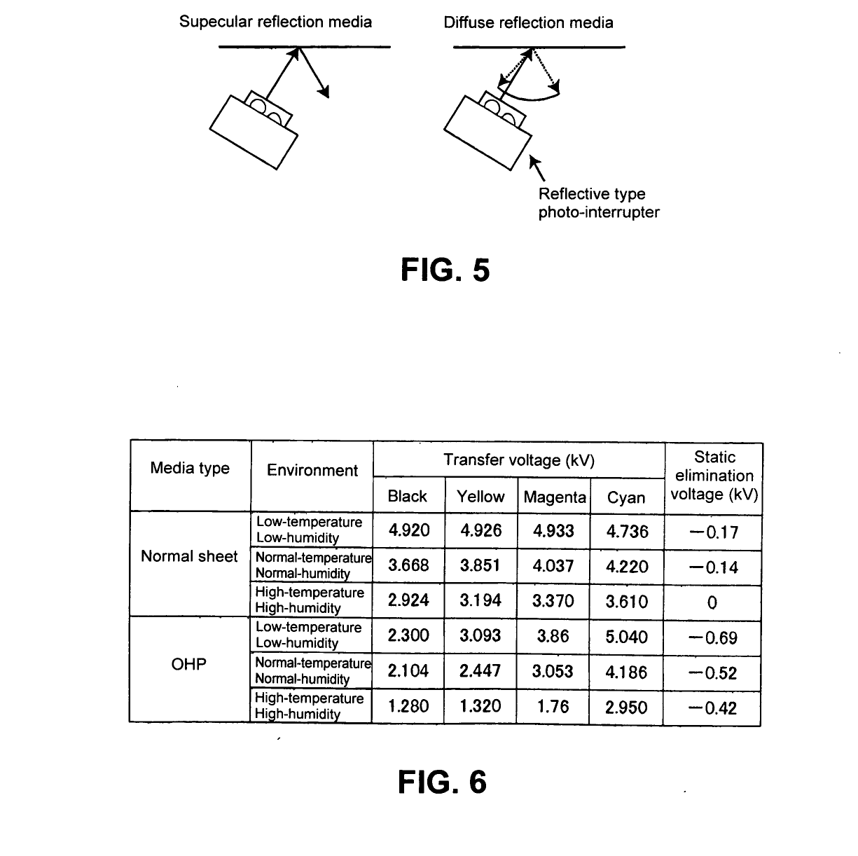

In the embodiment, the sheet quality sensor 14, i.e., a reflective type photo interrupter, is arranged obliquely at an angle of about 30 degree relative to the recording sheet 35. Therefore, when the recording sheet 35 is a specular reflection medium such as an OHP or a film medium, light reflected from the specular reflection medium does not return to the reflective type photo-interrupter. On the other hand, when the recording sheet 35 is a diffuse reflection medium such as a normal sheet, light is diffused and reflected, so that light returns to the reflective type photo-interrupter. The sheet quality sensor 14 detects a difference in reflectance of the media to determine sheet quality (refer to FIG. 5).

In addition, in Step S205, the environment sensor 110 measures a temperature and a humidity inside the printer 1. Accordingly, the sheet quality sensor 17 determines the sheet quality, and the environment sensor 110 measures the temperature and the humidity inside the printer 1.

FIG. 6 is a table showing a relationship among the sheet quality, an environmental condition, a transfer voltage, and the static elimination voltage according to the first embodiment of the present invention. Based on the table shown in FIG. 6, the CPU 101 determines the transfer voltage and a voltage to be applied to the static elimination brushes 31 and 32 according to the sheet quality determined by the sheet quality sensor 17 and the temperature and the humidity measured by the environment sensor 110. Note that before the recording sheet 35 reaches the static elimination brushes 31 and 32, the recording sheet is positively charged through the transfer voltage of the transfer unit and friction with the convey path.

In FIG. 6, “low temperature-low humidity” in a column of “environment” indicates an environmental condition of temperature 10° C. and 20% humidity. Similarly, “normal temperature-normal humidity” indicates an environmental condition of 20° C. temperature and 50% humidity, and “high temperature-high humidity” indicates an environmental condition of 28° C. temperature and 80% humidity. The environmental sensor 110 measures an actual environmental condition, i.e., an actual temperature and humidity. Then, an environmental condition close to the actual environmental condition is selected from “low temperature-low humidity”, “normal temperature-normal humidity”, and “high temperature-high humidity”.

For example, when the recording sheet 35 is a normal sheet and the actual temperature and humidity measured by the environmental sensor 110 are close to “normal temperature-normal humidity”, the transfer voltages of 3.668 kV (K), 3.851 kV (Y), 4.037 kV (M), and 4.220 kV (C) are applied to the transfer rollers 10, respectively. In addition, the static elimination voltage to be applied on the static elimination brushes 31 and 32 is −0.14 kV.

The convey rollers 15 and 16 further convey the recording sheet 35 in the printing direction, so that the recording sheet 35 reaches the writing sensor 17. When the writing sensor 17 detects the recording sheet 35, the CPU 101 sends a direction to the image control unit 103 to transfer the image data to the LED head 5K after a certain period of time. In Step S206, after the LED head 5K receives the image data, the LED head 5K starts exposure, thereby forming the electrostatic latent image on the photosensitive drum 3K. The developing roller 6K supplies toner onto the electrostatic latent image, thereby developing the electrostatic latent image.

In Step S207, when the recording sheet 35 reaches between the photosensitive drum 3K and the transfer roller 10K, the high-voltage power supply 107 applies a voltage of +2,000 to 5,000 V to the transfer roller 10K, so that toner on the photosensitive drum 3K is transferred onto the recording sheet 35. Here, the transfer voltage determined in Step 205 is applied to the transfer roller 10K.

In Step S208, after the image forming unit 2K forms the image in the steps described above, the image forming units 2Y, 2M, and 2C successively form images, and the transfer voltages determined in Step S205 are respectively applied onto the transfer rollers 10Y, 10M, and 10C.

After toner is transferred onto the recording sheet 35 completely, the recording sheet 35 is conveyed to the fixing device. In the fixing device, the fixing roller 21 and the fixing backup roller 22 apply heat and pressure to the recording sheet 35 therebetween, so that toner is to the recording sheet 35.

In Step S209, the ejection sensor 23 detects the recording sheet 35 ejected from the fixing device. The up-down separator 26 selects one of the face-down stacker 24 and the face-down stacker 25 to which the recording sheet 35 is ejected outside the printer 1.

When the recording sheet 35 is ejected to the face-up stacker 24, the CPU 101 sends a direction to the sheet-feeding, conveyance, and fixing driving unit 106, and rotates the convey rollers 27 and 28. In addition, the CPU 101 sends a direction to the static elimination power supply 109 to apply the static elimination voltage determined in Step S205 onto the static elimination brush 32.

When the recording sheet 35 is ejected to the face-down stacker 25, the CPU 101 sends a direction to the sheet-feeding, conveyance, and fixing driving unit 106, and rotates the convey rollers 29 and 30. In addition, the CPU 101 sends a direction to the static elimination power supply 109 to apply the static elimination voltage determined in Step S205 onto the static elimination brush 32. In Step S210, when the static elimination power supply 109 receives the direction from the CPU 101, the static elimination power supply 109 applies the static elimination voltage to the static elimination brush 32.

In Step S211, the writing sensor 17 monitors a rear edge of the recording sheet 35, and when the recording sheet 35 passes the writing sensor 17, an output of the writing sensor 17 is turned off.

In Step S212, when the writing sensor 17 is turned off in Step S211 (Yes in Step S211), after a certain period of time, the CPU 101 turns off the high-voltage power supply 110 and the static elimination power supply 109, and the process routine returns to a print request waiting mode in Step S202.

According to the first embodiment of the invention, the printer includes the static elimination brushe provided at the outlet of the recording sheet for eliminating charges. Further the static elimination voltage is determined based on the parameters, i.e., the type of recording sheet, temperature, and humidity, and the static elimination voltage is applied the static elimination brush, thereby removing charges on the recording sheet. Therefore, it is possible to prevent the recording sheet from being adsorbed to or rejected from other recording sheet already conveyed, thereby preventing the recording sheet scattering on a stacker.

In addition, it is possible to prevent the recording sheet from being stained with toner when the recording sheet is absorbed to other recording sheet already conveyed due to remaining charges on the recording sheet.

In the embodiment, it is possible to adjust the voltage values in the table shown in FIG. 6 as necessary. An OHP or a film medium has high impedance and is easily charged. Accordingly, in the table, the static elimination voltage to be applied to an OHP or a film medium via the static elimination brushe is set higher than that for a normal sheet.

In addition, in a case of the high temperature-high humidity condition, a medium is hardly charged because of humidity. Accordingly, the static elimination voltage is not applied to a normal sheet, and the static elimination voltage relatively lower than that in the low temperature-low humidity or normal temperature-normal humidity condition is applied to an OHP or a film medium.

### Second Embodiment

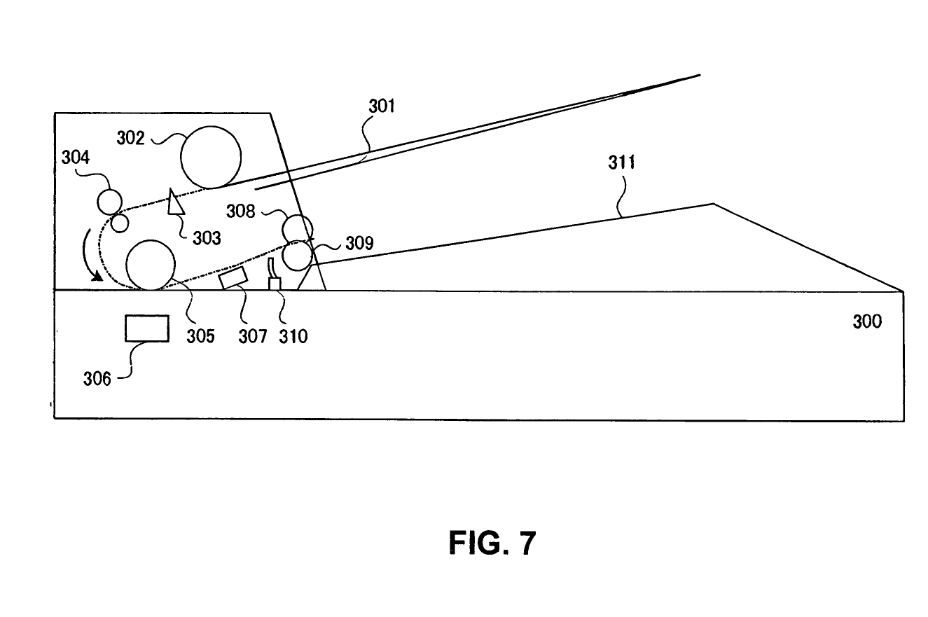

A second embodiment of the present invention will be explained next. FIG. 7 is a schematic sectional view showing a major portion of a scanner 300 as an image processing device according to the second embodiment the present invention.

As shown in FIG. 7, the scanner 300 has a document base 301 to set a document thereon to read; a sheet-feeding roller 302 to attract the document; an inlet sensor 303 to detect a front edge of the document; convey rollers 304 and 305 to convey the document; a CCD (charge coupled device) line sensor 306 to read the document once the document reaches a specified position; a potential sensor 307 to measure charges on the document; ejecting rollers 308 and 309 to eject the document; a static elimination brush 310 to switch and apply a voltage to the document based on a charged condition of the document measured by the potential sensor 307; and a stacker 311 to temporarily hold the document thus read.

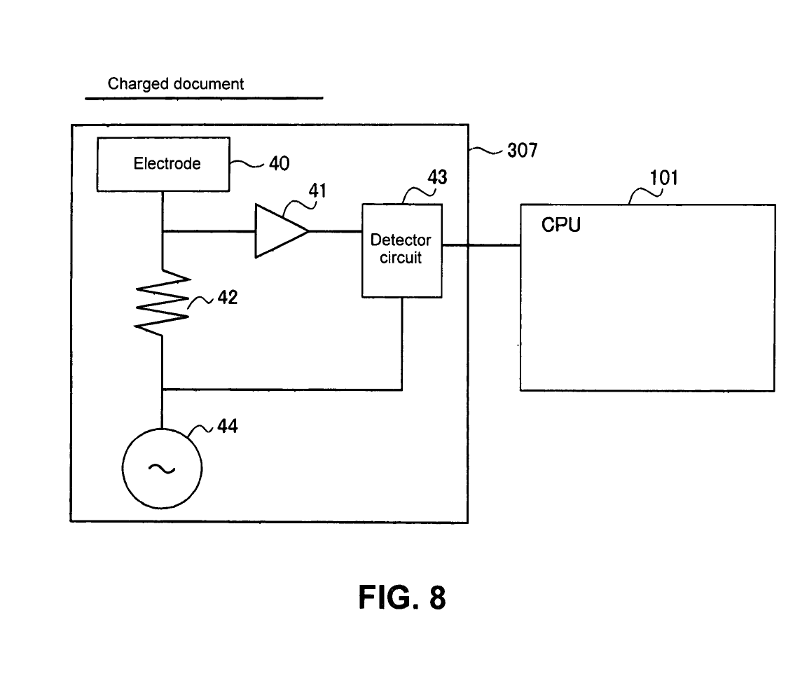

FIG. 8 is a schematic view showing the potential sensor 307 according to the second embodiment of the present invention. As shown in FIG. 8, the potential sensor 307 has an electrode 40, an amplifier 41, a resistance 42, a detector circuit 43, and a pulsating power supply 44. When the document reaches a part of the electrode 40, the potential sensor 307 detects charges accumulated on the electrode 40 according to an electric potential of charges on the document. The pulsating power supply 44 applies a pulsating voltage for determining whether the electrode 40 is charged positively or negatively and for eliminating noises.

In the embodiment, the detector circuit 43 eliminates an alternate component from the electrode 40, and extracts a direct current component therefrom and sends the direct current component to the CPU 101. A built-in A/D converter (not shown) is used for detecting an electrode voltage in the CPU 101, and the CPU 101 can read analog values of 0 to 5 V. When the document is charged with a charge voltage of 0 V, the detector circuit 43 outputs a voltage of 2.5 V. The resistance 42 is adjusted so as to add 1/1000 of the charge potential of the document.

In the embodiment, the scanner 300 also has a motor (not shown) to rotate each roller described above and a control circuit (not shown) of the motor.

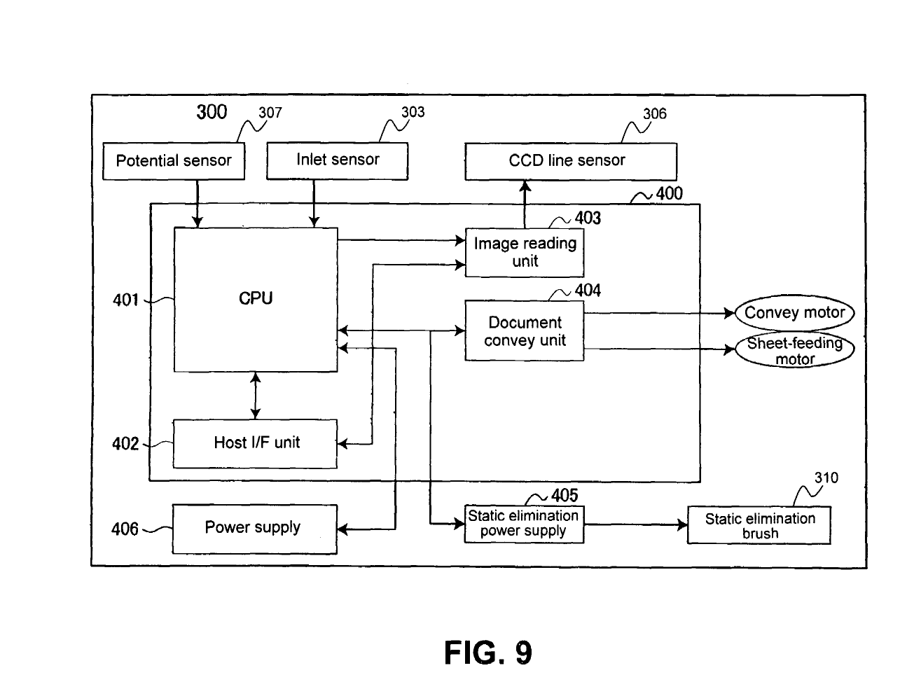

FIG. 9 is a block diagram showing a scanner control unit 400 of the scanner 300 according to the second embodiment of the present invention.

As shown in FIG. 9, the scanner control unit 400 includes a CPU 401 that operates with a program written in a ROM (not shown); a host I/F unit 402 that makes wired or wireless connection with an external device such as a host computer; an image reading unit 403 to read out an image on the document per line from the CCD line sensor 306; and a document convey unit 404 to control a sheet-feeding motor and a convey motor. In addition, the scanner 300 has a static elimination power supply 405 to apply a static elimination voltage to the static elimination brush 310; and a power supply 406 to apply voltages of 3.3 V, 5 V, and 24 V to the scanner control unit 400.

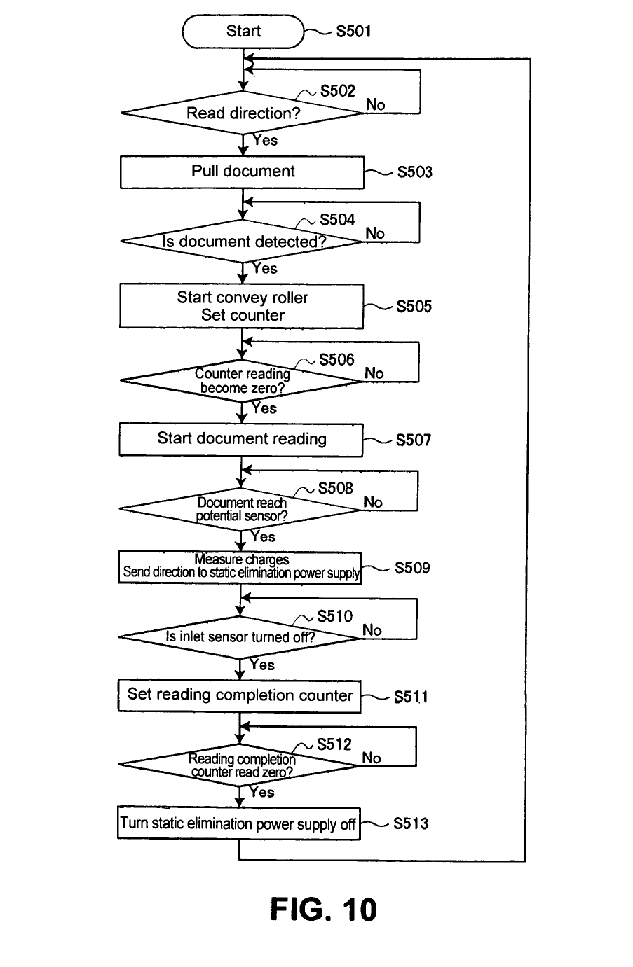

Hereunder, an operation of the scanner 300 will be described. FIG. 10 is a flowchart showing the operation of the scanner 300 according to the second embodiment of the present invention. The scanner 300 is connected to a host computer or the like via the host I/F unit 402.

In Step S501, when the scanner 300 is turned on, the CPU 401 reads the program recorded in the ROM (not shown) and thereby starts a process routine.

In Step 502, the CPU 401 receives a direction to read the document from the host computer or the like, the CPU 401 sends the direction to the document convey unit 404, so that the document convey unit 404 drives the sheet-feeding motor and the convey motor. When a driving force is transmitted to the sheet-feeding roller 302 from the sheet-feeding motor, the sheet-feeding roller 302 starts rotating. In Step S503, the document set on the document base 301 is pulled into the scanner 300, and then further transported to the convey rollers 304 and 305.

In Step S504, the inlet sensor 303 located on an upstream side of the convey rollers 304 and 305 detects whether the sheet-feeding roller 302 pulls the document normally. When the inlet sensor 303 detects the document (Yes in Step 504), the convey rollers 304 and 305 start rotating to send the document to the CCD line sensor 306.

In Step S505, a counter is set to start document reading. The counter counts down by a timer interruption, and once the counter reads zero, the document reading starts. In Step S506, the document reading is suspended until the counter reading becomes zero. In Step S507, when the counter reading becomes zero, the document reading starts.

When the counter reads zero, the CPU 101 sends a direction to the image reading unit 403, and the CCD line sensor 306 starts the document reading. The CCD line sensor 306 reads the document based on a cycle fitted to a traveling speed and a resolution of the document.

In the embodiment, the CCD line sensor 306 reads the document at the document traveling speed of 140 mm/s, the resolution of 600 dpi, and the cycle of about 0.3 ms. After the CCD line sensor 306 reads the image data, the image data are sent to the host computer or the like via the host I/F unit 402.

In Step S508, when the CCD line sensor 306 completes the document reading and the document reaches the potential sensor 307, the potential sensor 307 measures charges on the document. In Step S509, according to a measurement result of the potential sensor 307, the CPU 401 sends a direction to the static elimination power supply 405 to apply a voltage with polarity opposite to and equal to one tenth of the voltage charged on the document to the static elimination brush 310.

The inlet sensor 303 monitors the rear edge of the document. In Step S510, when the document passes the inlet sensor 303, the CPU 401 turns off the inlet sensor 303, and the process routines proceeds to Step S511.

In Step S511, a reading completion counter is set. The reading completion counter is also done through a timer process. In Step S512, the process waits for completion of the reading completion counter in Step S511. When the reading completion counter reads zero, the process routine proceeds to Step S513 (Yes in Step S512).

In Step S513, when the reading completion counter reads zero, the CPU 401 turns off the static elimination power supply 405, and the process routine returns to the document reading request waiting mode in Step S502.

In the second embodiment, the scanner has the static elimination brush provided at the document outlet for eliminating charges on the document. The voltage to be applied the document is controlled based on the measuring result of the charge with the potential sensor, thereby eliminating charges. Therefore, it is possible to prevent the recording sheet from being adsorbed to or rejected from other recording sheet already conveyed, thereby preventing the recording sheet scattering on a stacker.

In the embodiment, the potential sensor is formed of the electrode for reading the voltage of the document, the amplifier, the resistance, the detector circuit, and the pulsating power supply. Alternatively, an alternate voltage is applied to the electrode, so that charges on the document can be measured through filtering using a reverse phase alternate voltage.

In addition, the potential sensor may be provided at a position to measure charges on the document ejected on a stacker. In this case, as opposed to the case that charges on the document are measured while the document is conveyed, it is possible to stably measure charges.

In the embodiment, the static elimination brush has a certain potential difference relative to the document, so that the static elimination brush discharges or generates ions to remove charges on the document. The static control brush is controlled to maintain at least 1.5 kV of the potential difference with polarity opposite to charges without contacting with the document. Alternatively, the static elimination brush may directly contact with the document to decrease a voltage of the document.

In the first embodiment, the invention is applied to the LED printer, in which the transfer voltage and the static elimination voltage are controlled to eliminate charges on the medium. The invention may be applied to a printer or a copier, which uses an electronic photograph.

In the second embodiment, the potential sensor measures charges on the medium to eliminate charges. The present invention can be applied to devices other than a scanner, such as a printer or a medium conveying device, as long as the medium is charged through contact with the convey path.

The disclosure of Japanese Patent Application No. 2007-224074, filed on Aug. 30, 2007, is incorporated in the application.

While the invention has been explained with reference to the specific embodiments of the invention, the explanation is illustrative and the invention is limited only by the appended claims.

What is claimed is:

1. An image forming apparatus for forming an image on a medium, comprising:
a conveying unit for conveying the medium; and
a reverse voltage applying unit for applying a first voltage to the medium, said first voltage having polarity opposite to a second voltage charged on the medium while the conveying unit conveys the medium.

2. The image forming apparatus according to claim 1, wherein said reverse voltage applying unit is adopted to adjust the first voltage according to at least one of a type of medium, a temperature, and a humidity.

3. The image forming apparatus according to claim 1, further comprising a voltage detection unit disposed on an upstream side of the reverse voltage applying unit in a direction that the conveying unit conveys the medium for detecting the second voltage, said reverse voltage applying unit applying the first voltage to the medium according to a detection result of the voltage detection unit.

4. An image processing apparatus, comprising:
a conveying unit for conveying a original document;
a reading unit for reading an image on the original document; and
a reverse voltage applying unit for applying a first voltage to the original document, said first voltage having polarity opposite to a second voltage charged on the original document while the conveying unit conveys the original document.

5. The image processing apparatus according to claim 4, further comprising a voltage detection unit disposed on an upstream side of the reverse voltage applying unit in a direction that the conveying unit conveys the original document for detecting the second voltage, said reverse voltage applying unit applying the first voltage to the original document according to a detection result of the voltage detection unit.
